(19) United States
(12) Patent Application Publication
(10) Pub. No.: US 2008/0293393 A1
(43) Pub. Date: Nov. 27, 2008

(54) System and Method for Providing Commercial Broadcast Content Information to Mobile Subscribers

(76) Inventor: Peter J. Hartmaier, Woodinville, DC (US)

Correspondence Address: SLATER & MATSIL, L.L.P., 17950 PRESTON RD, SUITE 1000, DALLAS, TX, 75252-5793, US

(21) Appl. No.: 12/161,271

(22) PCT Filed: Feb. 5, 2007
(86) PCT No.: PCT/US07/03183

§ 371 Date: Jul. 17, 2008

Related U.S. Application Data
(60) Provisional application No. 60/765,867, filed on Feb. 7, 2006.

(51) Int. Cl. H04M 3/42

(52) U.S. Cl. 455/414.3

(57) ABSTRACT

System and method for providing information regarding broadcast content, such as advertising, commentary, music, or sports, to a wireless device. A preferred embodiment comprises sending a broadcast station identifier and a user identifier to a host server. The host server identifies the station and retrieves a list of content for the station. The content list is sent as a playlist to the wireless device for display to a user. The user identifies desired content and the host server sends specific information about the content to the user, such as a telephone number or webpage for an advertiser. The user can connect directly to the telephone number or webpage from the wireless device.

This application claims the benefit of U.S. Provisional Application No. 60/765,867 filed on Feb. 7, 2006, entitled SYSTEM AND METHOD FOR PROVIDING COMMERCIAL BROADCAST CONTENT INFORMATION TO MOBILE SUBSCRIBERS, which application is hereby incorporated herein by reference.

### TECHNICAL FIELD

The present invention is directed generally to providing information related to commercial broadcast content and, more particularly, to providing mobile subscribers and users of radio with links to information associated with radio advertisers and other content played.

### BACKGROUND

When a listener hears an advertisement, commentary, program, or song during a radio broadcast, the listener has no way of directly accessing information about the advertiser, program, song, or related products or services, other than calling a telephone number or looking at a website that might be identified during the advertisement or program. If the listener does not copy down the telephone number or Internet website address during the commercial, then the advertiser may lose sales from an otherwise interested listener because the listener did not later know how to contact the advertiser. To find out more information about the advertiser, the listener would have to wait for the commercial to be played again or the listener may have to do an Internet search in an attempt to identify the advertiser. If the listener uses the Internet to do a search for advertiser information, the radio station loses revenue that it otherwise might have gained by providing a billable lead to the advertiser. Typically, an Internet search provider will provide the listener with a link directly to the advertiser's website and, in some cases, charge the advertiser for this lead, revenue that is lost to the radio station. As a result, the advertiser is unaware that the listener received information from a radio broadcast. Without access to the content or program material, the radio station loses out on the ability to build a loyal listener audience and to receive revenue for specific leads generated to advertisers or by selling songs or content.

### BRIEF SUMMARY

The present invention is directed to a system and method that provides mobile subscribers with information associated with recently played advertisements, commentary, songs, or other content on a commercial radio broadcast. Using a mobile device, a listener can obtain a playlist of recent content for the radio broadcast. The playlist (the name or other unique identifier of content) is displayed on the listener's mobile device and may include information such as a song playlist, list of advertisers, names of radio program hosts or guests. The listener selects content of interest, such as an advertisement, and connects directly to a telephone number or webpage for that advertiser. Accordingly, the listener never has to remember or write down the telephone numbers or Internet website addresses that are provided during a broadcast. Also, because the listener can directly and immediately contact the advertiser or get more information about the advertised product or service, the advertiser is likely to achieve increased sales and the radio station can be credited for providing customer leads to the advertiser.

In one embodiment, the present invention uses existing Short Message Service (SMS) messaging technology. When a listener hears an advertisement of interest, the listener enters a radio station frequency or other identifier on a mobile device, such as a mobile telephone. The radio station frequency or other identifier is sent as part of an SMS message. The destination address of the SMS message is a device, such as a server connected to the Internet or the listener's wireless network that hosts a radio playlist application. The destination address may be a common address that is used to access content from all radio stations that are configured for this service. The Short Message Service Center (SMSC) forwards the SMS message to the host device.

When the SMS message is forwarded by the SMSC, location information can be added to the message. The location information identifies a geographical area in which the listener is operating. This location or geographical area may be, for example, an identification of a city or county that is served by a particular Mobile Switching Center (MSC) that is being used by the listener. The identity of the MSC may be sent with the SMS message that contains the radio station frequency or other identifier. In one embodiment, two items are provided when the listener triggers the SMS message, such as by clicking on a menu selection. A radio station identifier and a unique user ID, such as the phone number or electronic serial number of the mobile, can be used to identify the user. The radio station is either explicitly identified by the radio station's call letters in the SMS message, or computed using a radio station frequency entered in the message in connection with the location of the mobile. The user ID is provided by the SMS or mobile network or by the digital radio ID.

In another embodiment, a digital radio can be equipped to communicate directly with the playlist host server, such as via a wireless network. The digital radio may be further equipped with a “click button” that requests content information in a similar manner as the mobile phone. Activating the “click button” will send unique user identification and content reference information to the server.

In another embodiment, the destination address of the SMS message does not correspond to a playlist host server having a common short code, but is a branded short code unique to the radio station. In this embodiment, the radio station ID does not need to be entered into the message because the message will be directed to a specific radio station playlist server. A blank SMS message or an SMS message with any text (some systems cannot send blank SMS messages) that is received by the radio station server indicates to the radio station playlist server that the listener is requesting more information regarding the current content.

In another embodiment, the SMS message or trigger may include data identifying a past time period, which indicates to the common host playlist server or the radio station playlist server that content played during the identified past period is being requested. This allows the user to request information about content played at anytime in the past, such as content from minutes, hours, or days prior to the request.

When the radio playlist application on either a common host server or a dedicated radio station server receives the SMS message, it correlates the radio station frequency and location information to a particular radio station. The radio frequency can be entered by the listener or sent in the SMS message with or without the decimal point. For example, 98.3 and 983 refer to the same radio station frequency. Alternatively, the actual station call sign letters for the radio station may be provided in the SMS message. The radio playlist application then retrieves a playlist of the most recent content broadcast on that radio station, such as a list of advertisements, commentators, songs or other content. The radio playlist application then sends the playlist to the mobile device in an SMS message. The playlist may be sent as a numbered menu list that is displayed on the listener's mobile device. The listener can then select the number of the menu item of interest or highlight and “click” the desired menu item. For example, the listener may reply with the menu number of a recently played advertisement. The mobile device then sends the menu selection in an SMS message to the radio playlist application, which looks up specific information for the selected advertisement. The radio playlist application then sends another SMS message to the mobile device with specific information about the advertiser, such as a telephone number or Internet webpage address. The listener can then call the telephone number or link to the Internet webpage address of the advertiser for more information.

Alternatively, if the listener selects a song from the menu list, the radio playlist application may send an SMS message to the mobile device with a link to a site for downloading the song. If the listener selects other content, such as a radio program host's monologue or commentary, from the playlist, then the radio playlist application may send an SMS message with a link to a webpage address for the host or for the radio program. All other content in the radio station broadcast may be similarly linked.

The present invention allows listeners to treat a radio broadcast as an Internet webpage in that the listener can link to other information from the radio broadcast. The songs, advertisements, commentary, sports, news and other radio content can be treated as links to other information using the present invention. Similar to clicking on a link on one webpage to get to a new webpage, a listener using the invention described herein can “click” on a list of radio broadcast content to link to a new webpage, to call an advertiser, to download a song, or to get other information. The list of radio broadcast content may be displayed on the listener mobile telephone in response to entry of the identifier or frequency for the radio station making the broadcast.

Each selection of content may be considered a lead and can trigger a billing event, typically to an advertiser, but optionally to the mobile user, wireless network operator, service provider, radio station, or some combination of such entities. An aspect of this invention is that it provides a mechanism to bill for the service and to distribute that revenue to the various parties. Fees charged to the advertiser, for example, may be shared with both the radio station and the wireless service provider. The subject invention provides a source indication for both the requested content and the requesting device, such as a mobile device or a digital radio, which allows for revenue to be split among various parties.

The common host server aggregates the content of all radio stations using this service. Well known secure data transfer means are used to copy data from the station's playlist storage media to the common host. It is a feature of this invention to bring together into a common searchable database all such playlists, identifying the source radio station and the scheduled time or actual time the content was played.

In another embodiment, the mobile phone or personal computer may connect to the common host server via a WAP connection or the Internet and view a page of currently or recently played content for a specific station. The user can then select the content of interest.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 illustrates a network for providing radio content playlist information to mobile subscribers in an exemplary embodiment;

FIGS. 2A-2D are flowcharts that illustrate messages that would be used in an exemplary embodiment to provide playlist information to listeners; and

FIG. 3 illustrates three exemplary displays for a mobile device incorporating the present invention.

### DETAILED DESCRIPTION OF THE INVENTION

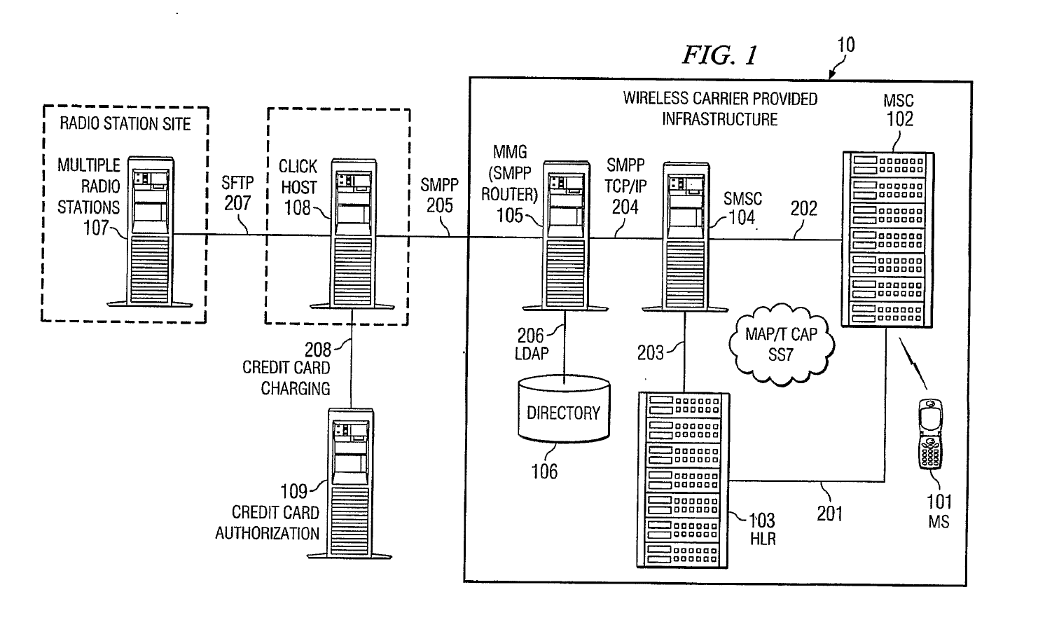

Referring to FIG. 1, click host 108 is shown connected to wireless carrier provided infrastructure 10, radio stations 107, and credit card authorization server 109. Click host 108 represents a radio playlist application that may provide radio broadcast content information to mobile subscribers 101. Click host 108 may aggregate the playlists from all the broadcast stations. It will be understood by those of skill in the art that FIG. 1 is a simplified diagram and that other components, routers, servers and the like may be used to implement the system. However, those elements are not critical to the implementation of the present invention and are not shown in FIG. 1.

Wireless carrier provided infrastructure 10 includes mobile switching center (MSC) 102 that is in communication with one or more mobile subscribers 101 through one or more base stations, base station controllers, or base station subsystems as is well known to those of skill in the art and, therefore, not illustrated in FIG. 1. The type of wireless access provided to mobile subscriber 101 is not critical and may be, for example, any now known or later developed TDMA, CDMA or other system using any transmission, modulation, or access method provided by any service provider. MSC 102 is coupled to home location register 103 via connection 201 and to SMSC 104 via connection 202. SMSC 104 and HLR 103 may also communicate via connection 203. HLR 103 maintains subscriber service profile and location information for mobile subscriber 101 as is known in the art.

SMSC 104 is connected to short message peer to peer (SMPP) or other protocol router 105, which may be, for example, a multimedia gateway. SMPP router 105 is connected to directory 106 via connection 206 and to click host 108 via SMPP connection 205. Click host 108 is connected to radio stations server 107 via connection 207 and to credit card authorization server 109 via connection 208. It will be understood by those of skill in the art that router 105 may also be connected directly to or communicate with radio station server 107 without having to go through host 108.

When a radio station listener hears radio content, such as an advertisement, and desires to get more information about the content, the listener can use MS 101 to obtain additional information or to contact an advertiser. MS 101 sends a trigger that prompts the return of the content information. The listener selects a radio content application on MS 101, such as a dedicated GUI application or an existing text messaging client, that allows the listener to enter the radio station's frequency or call letters. The radio content application then creates a text (SMS) message that includes the radio station identifier, such as a frequency or call letters entered by the listener, and sends the SMS message to click host 108.

The SMS message identifies click host 108 as the destination address and is first routed to through MSC 102 to SMSC 104, which may append location information associated with the listener. For example, SMSC 104 can identify MSC 102 and the general geographic area of MSC 102, such as the cities or counties served by MSC 102. SMSC 104 appends either the MSC identification or a location served by MSC 102 to the SMS message and forwards the message to SMPP router 105. Router 105 forwards the SMS message to click host 108. The location information for MSC 102 may be determined by SMPP router 105 or by a separate location application.

Upon receipt of the SMS message, click host 108 uses the radio station frequency information and the location information for MSC 102 to identify a specific radio station. Each radio station frequency, such as 93.1, is unique in a particular market, such as New York, Chicago, Dallas, or Seattle; however, each of those markets may have a radio station on 93.1. A mobile switching center, such as MSC 102, serves a limited geographic area, such as a city or portion of a city. Accordingly, MSC 102 can be linked to a particular city either by SMSC 104 or click host 108. Once the location of MSC 102 is identified, then click host 108 can identify the specific radio station operating at the frequency sent in the SMS message. For example, if a listener in Chicago enters “93.1” (or, for ease of use, “93.1”—i.e., without the decimal point) in a radio content application on MS 101, the application would send an SMS message to click host 108 through an MSC located in the Chicago area. Click host 108 would match the radio frequency with the location to identify radio station WXRT, which broadcasts on 93.1 FM in Chicago. Alternatively, the trigger message may contain the actual call sign (e.g., WXRT) in which case this resolution step is bypassed. Those skilled in the art will recognize that a less accurate (but useful) location resolution can be inferred by using the area code and office code of the mobile phone number, however, if the mobile is roaming this will not be sufficient.

The station identifier may also be the name of a broadcast television channel, such as The Discovery Channel, or the name of a broadcast company having multiple channels, such as HBO television or Infinity Broadcasting. In the case of nationally broadcast radio or television channels or stations, such as The Discovery Channel or ESPN Radio, the local cable service provider or radio station affiliate may include local advertisements in the broadcast or may not include all of the nationally provided content. Accordingly, the playlist may vary across the country and the listener's location would be used to identify the correct playlist information for such national broadcasts.

Click host 108 either maintains a playlist for the selected radio station or accesses a playlist database, such as on radio station server 107, to obtain a playlist for the selected radio station. The playlist is a list that identifies all or some of the content broadcast on the radio station, including, for example, songs, advertisements, commentary, public service announcements, and the like. Radio station server 107 may be a server supported by a specific radio station or it may be a centralized server that maintains playlists for multiple radio stations. Playlists may be uploaded by radio stations to server 107 in advance of the broadcast or in real-time or near-real-time as the content is being broadcast A preprogrammed radio station may be able provide a playlist of songs and advertising well in advance of the broadcast. Other radio stations may not know the specific content or songs that will be broadcast, but may know the approximate times that certain advertisements are going to be broadcast. Those stations may provide a partial playlist to server 107 or click host 108 before of the broadcast instead of a full playlist. The radio station may update its playlist as the content is broadcast to provide a final playlist to server 107 or click host 108. It will be understood that the source of the radio station content playlist does not have to be provided by the radio station itself, but may also be provided by a third party application that creates the playlist as the content is broadcast. For example, by monitoring the Radio Data System (RDS) or Radio Broadcast Data System (RBDS) channel.

Click host 108, after identifying a particular radio station and obtaining the recent playlist for that radio station, creates a reply SMS message that includes the playlist as a numbered list. Click host 108 sends the reply SMS message to MS 101, which displays the numbered playlist as a menu to the listener. The listener identifies the song, advertisement, or other content of interest in the playlist menu and enters the corresponding number from the menu. MS 101 then sends the selected number in a new SMS message to click host 108. Upon receiving the selected menu number, click host 108 retrieves content information about the selected content, such as a description of an advertised product or service, an advertiser's telephone number, an Internet website address for the advertiser, or an Internet website address to download a selected song. The content information is then sent to the listener in another SMS message. Upon receipt of the content information SMS message, MS 101 displays the content information to the user. If, for example, the content information includes an advertiser's telephone number or Internet website address, then the user can select the telephone number or web address to contact the advertiser directly.

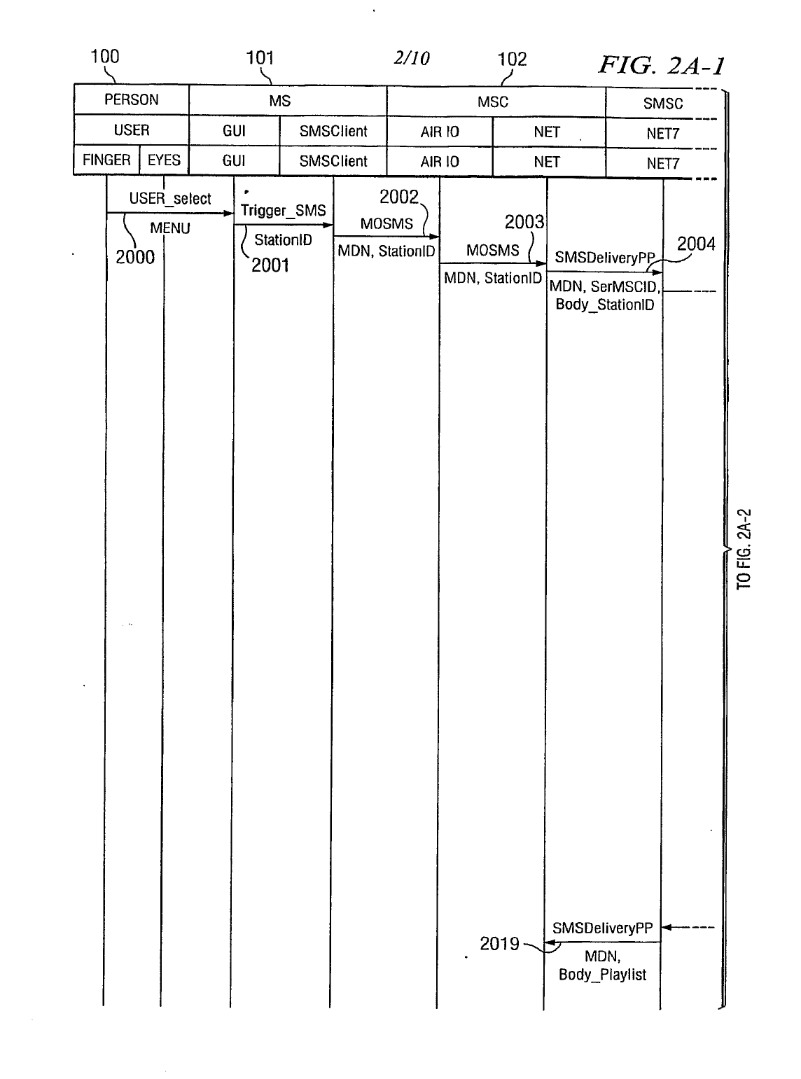

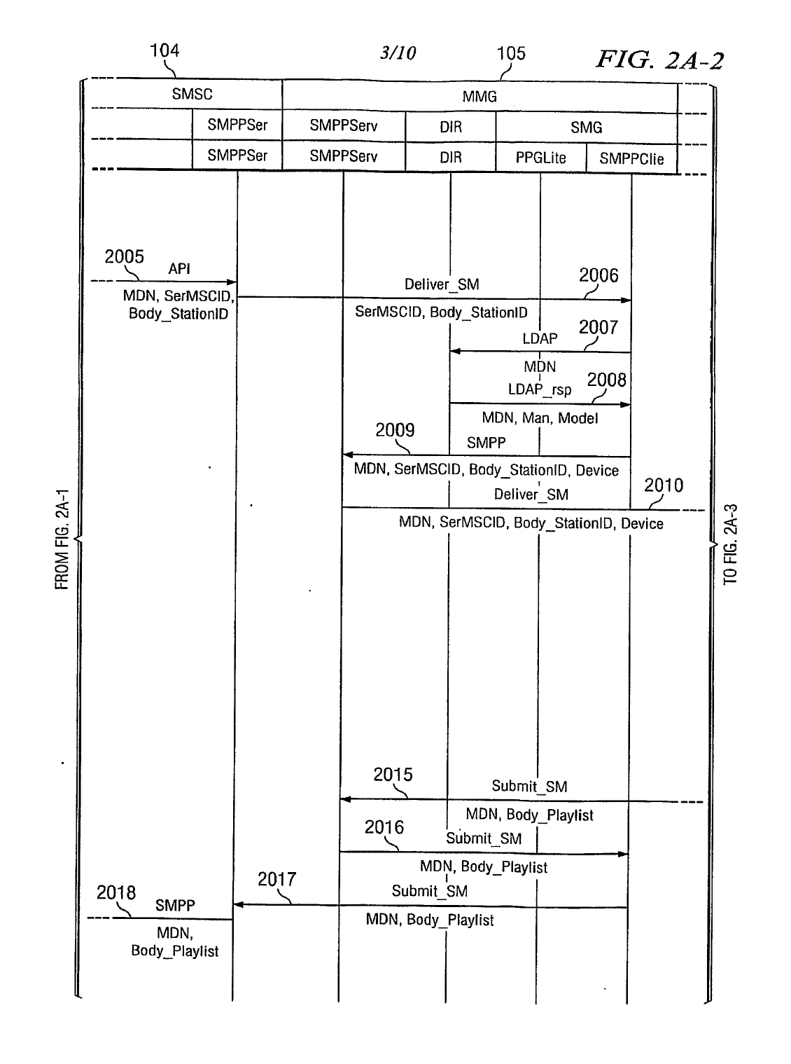

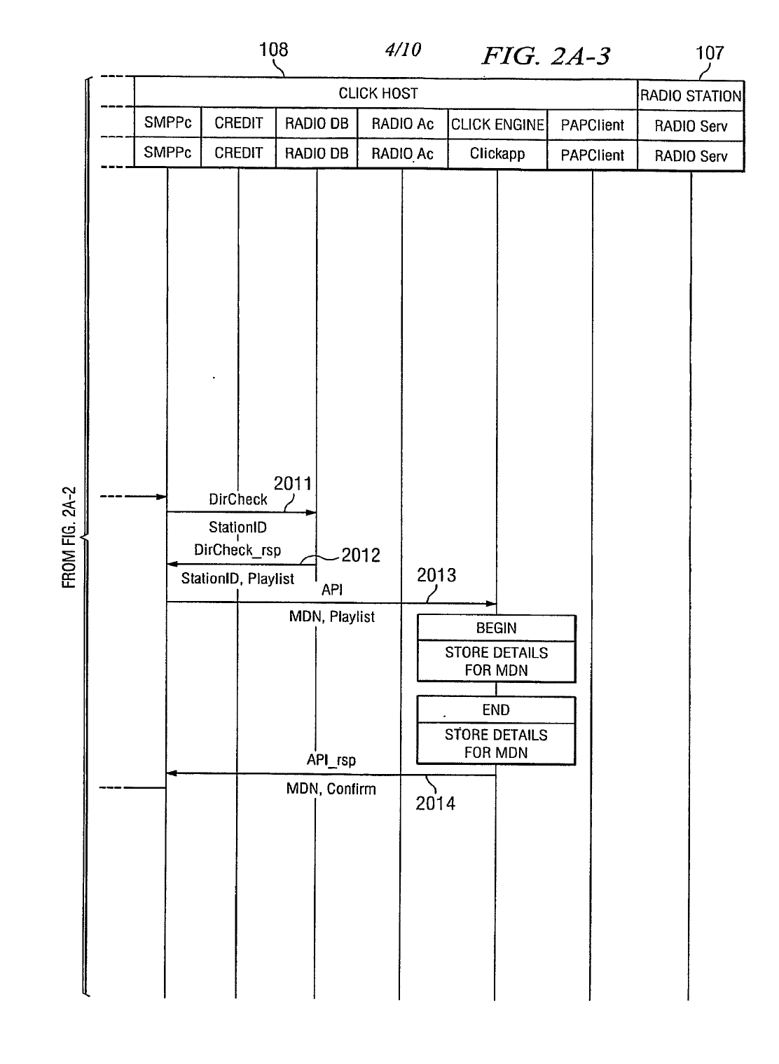

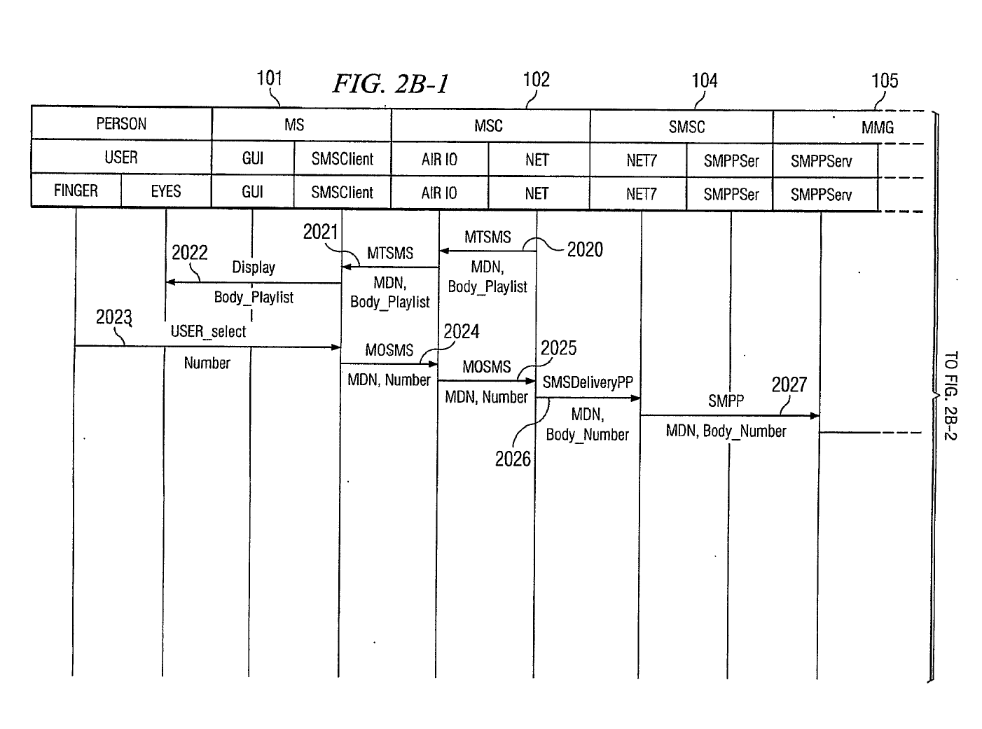

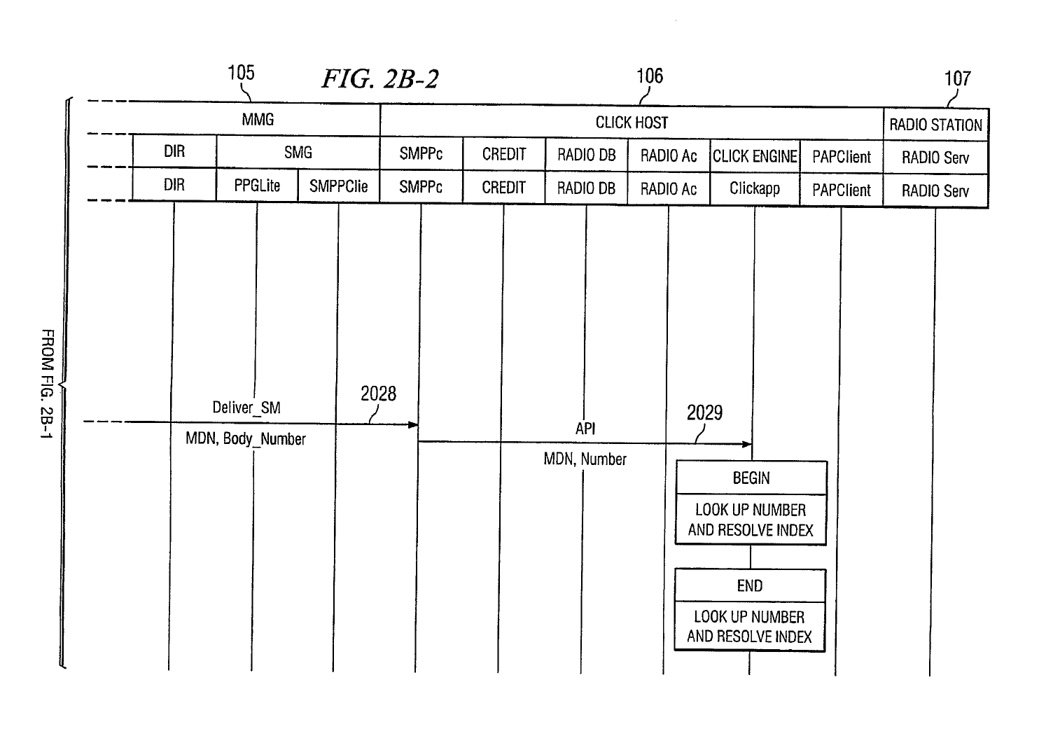

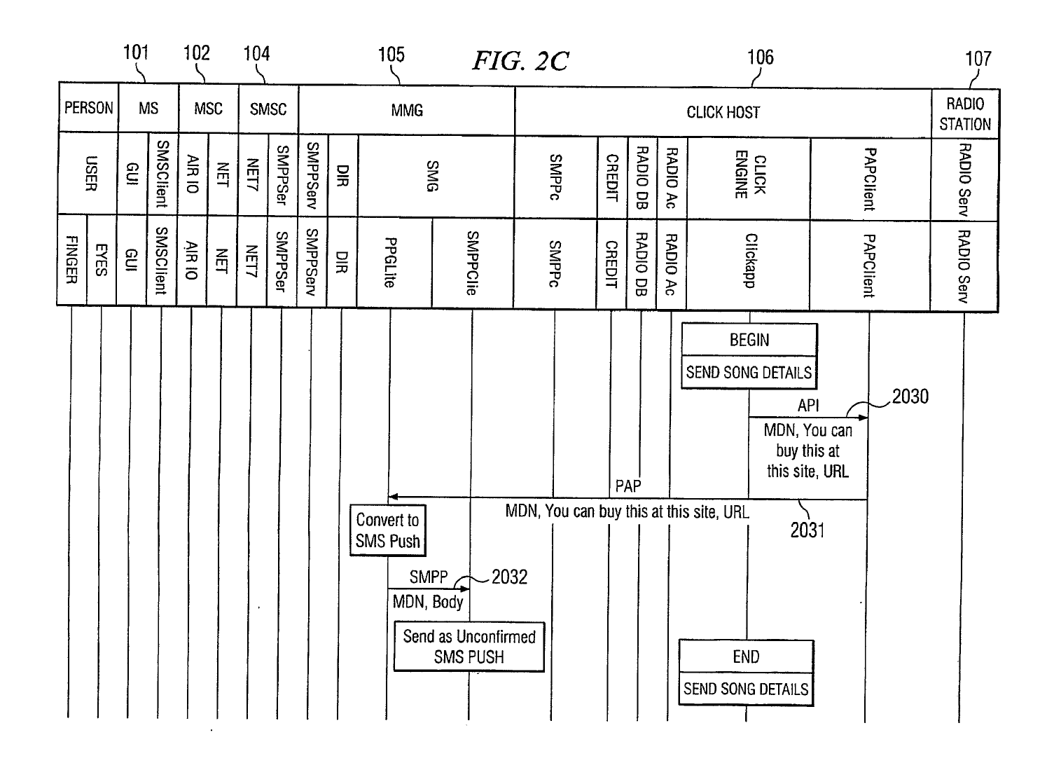

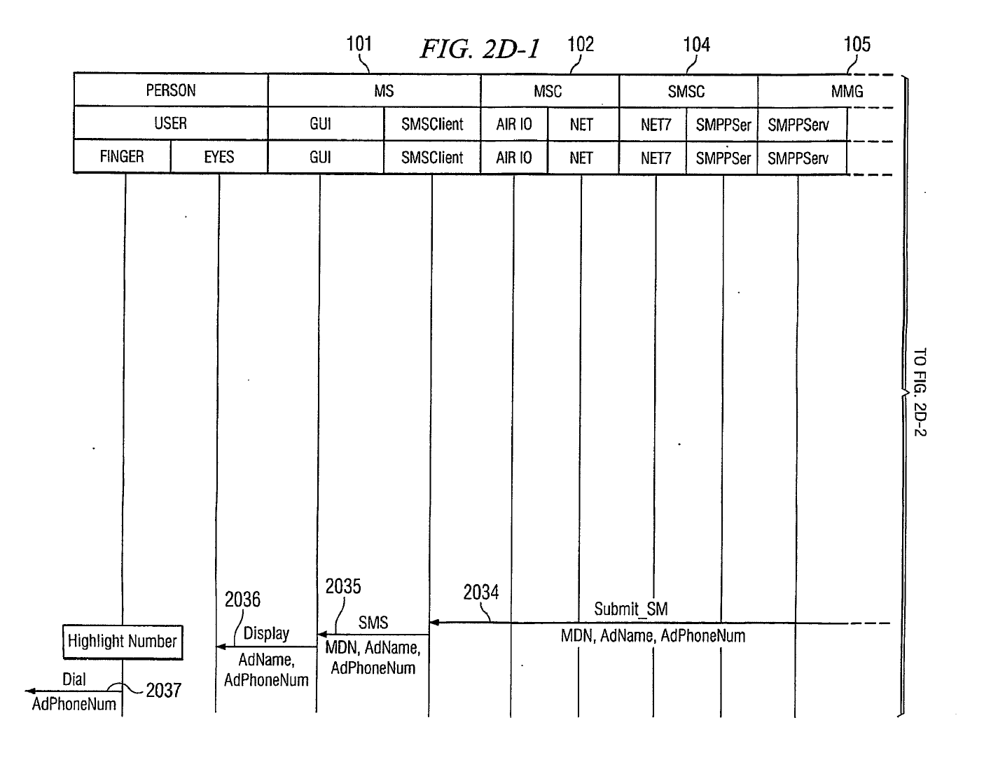

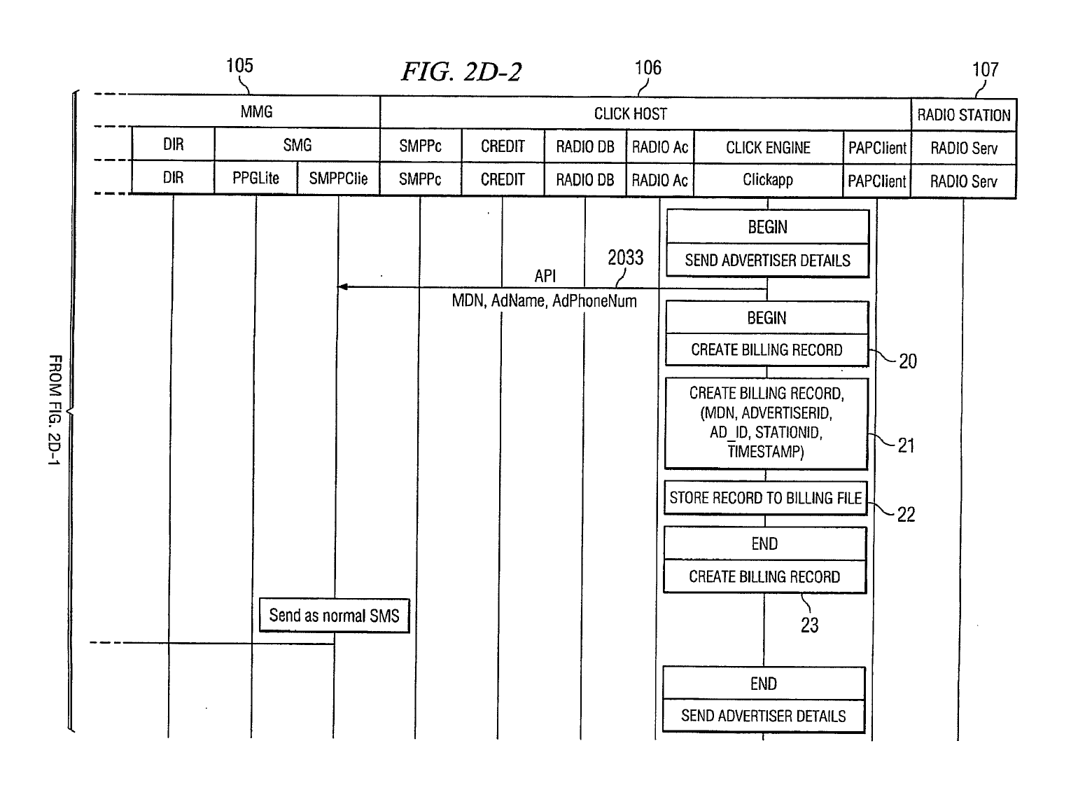

Referring to FIGS. 2A-2D, a series of messages are illustrated for an exemplary embodiment of the present invention. In step 2000, listener 100 enters a radio station identifier (StationID) in a mobile device 101 using a radio content application GUI. The StationID is sent via an SMS message (2001-2005) from MS 101 to SMSC 104, via MSC 102. MS 101 may include a mobile directory number (MDN) that identifies the make and model of MS 101 so that other applications can determine MS 101's capabilities for displaying information or presenting SMS or multimedia content to listener 100. MSC 102 may add a serving MSC identifier (SerMSCID) to the SMS message to identify the MSC that is in contact with listener 100. SerMSCID also allows other applications to determine the general location of MSC 102 and listener 100.

SMSC 104 sends the SMS message to MMG/SMPP router 105 in Deliver_SM message 2006. The format of the Deliver_SM message is described in the Short Message Peer to Peer Protocal Specification, which may be modified by the service provider to incorporate additional information, such as the SerMSCID parameter. SMPP router 105 further processes the SMS message and may do a directory look up (2007-2009) to add additional information to the SMS message, such as a manufacturer and model of MS 101. SMPP router 105 forwards Deliver_SM message 2010 to click host 108, which uses the StationID and SerMSCID information to determine a particular radio station associated with listener 100. Click host 108 also retrieves (2011-2014) the playlist for the radio station either from an internal database or from an external source, such as radio station server 107 (FIG. 1).

SMSC 104 then returns the playlist in Submit_SM message 2015 to SMPP router 105, which processes the message and forwards it to SMSC 104 (2016-2017). The playlist is forwarded on to MS 101 via MSC 102 (2018-2021) where it is displayed (2022) to listener 100. The playlist may be forwarded from click host 108 to MS 101 in the body of an SMS message. The playlist may be a numbered menu list that can be displayed to listener 100 on MS 101. The listener then selects (2023) the menu item of interest, such as a desired song or advertisement, by entering the menu number of the content. The menu number (Number) is forwarded to click host 108 an another series of SMS messages (2024-2029).

Click host 108 processes the menu number and obtains content information to be sent to listener 100. For example, the content information may include text describing a selected song or advertisement, a telephone number for an advertiser, or an Internet website address to download a song. For example, if the requested content is a song, the content information may be sent to the listener using an SMS Push message or the push access protocol (PAP) (2030-2032). If the requested content is an advertisement, the information is forwarded to MS 101 (2033-2035) where listener 100 can read the displayed information, call the advertiser's phone number, or link to a website address (2036-2037).

In FIG. 2D, steps 20-23 illustrate an exemplary process for creating billing records when a listener requests advertising content information. The click-host service provider (106) may store such billing records for later invoicing to advertisers. This would allow the service provider to obtain revenue for advertising leads provided to listeners via the present invention.

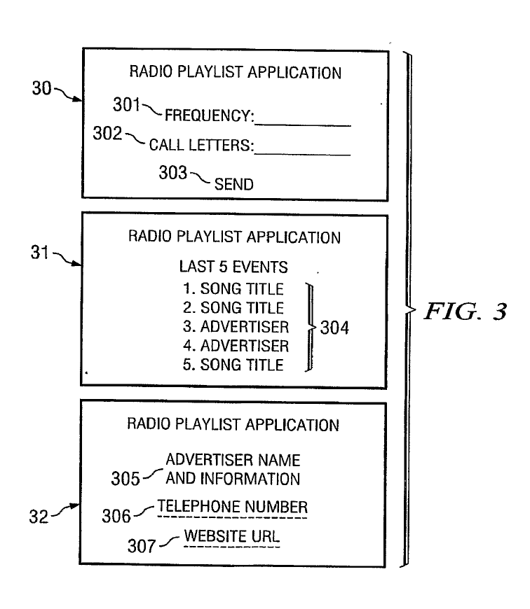

FIG. 3 illustrates three exemplary display screens 30-32 for a mobile device incorporating the present invention. Screen 30 illustrates an exemplary display shown to a listener. The listener can enter a radio station's frequency (301) or call letters (302) and then send (303) the information to a radio content application, such as in an SMS message to click host 108 as discussed above.

The manner of entering a desired radio station's frequency, call letters or other broadcast station's identifier may be accomplished manually or automatically. For example, in one embodiment, the listener's mobile device may include an application that is capable of identifying local broadcast stations, such as radio, television, cable or satellite stations that are in the listener's current area. Accordingly, instead of manually entering an identifier on screen 30, a list of such stations may be presented to the user as a menu. The user may then select a desired station from the list or menu. The selected identifier would then be sent to click host 108 as described herein.

When the radio content application identifies the radio station, it returns playlist information in an SMS message to the listener's mobile device where it may be displayed as shown on screen 31. The playlist may be shown as a numbered list (304) that allows the user to select the menu number of the desire content. The playlist may include song titles, advertiser names, products or services, or other radio broadcast content. The mobile device sends the selected menu number to the radio content application.

The radio content application provides content information for the selected content. The content is displayed to the listener as shown in screen 32. For example, if an advertisement is selected from menu list 304, the radio content application may provide the advertiser's name and information about the advertised product or service (305). The advertiser's telephone number (306) or website address (307) may also be displayed to the listener. The listener can select the telephone number (306) or website address (307) and contact the advertiser directly.

In other embodiments, the broadcast may be a sporting event and the content displayed to the listener on a menu may include a list of teams, players, coaches, managers, scores, innings, periods, quarters, games, schedules, and the like. The listener may select, for example, a particular player and be linked to a webpage of statistics for that player. In another embodiment, the listener may select a listed team, game, or schedule and would be connected to a telephone number for a ticketing agency.

In another embodiment, the listener may enter the identifier of the station that they are listening to or watching. A browser or click host application in the user's mobile device is then directed to a URL or other address for a server having playlist content, such as click host 108. The content server then provides continually updated playlist information to the listener for the selected broadcast station. For example, once the listener enters a broadcast station identifier, the user's mobile device notifies click host 108 to send updated information regarding the playlist for that station. The playlist may be updated each time a new song, advertisement or program beings. Alternatively, the playlist may be updated at periodic intervals, such as at a preset number of minutes or seconds.

The listener can then select any content of interest from the playlist to obtain additional information from click host 108. Accessing a playlist item via a menu on the mobile device's browser would have the same effect as sending a text message as described herein. By updating the browser's playlist display from the central database of aggregated content (e.g., click host 108), the mobile device becomes a virtual Radio Data System (RDS) display device that can also implement an action against the content (i.e. “click” on the content). In the situation where a user is listening or watching a particular program, channel or station, this embodiment would allow the user to immediately access content without having to enter or reenter the identifier.

Although the present invention is described above in connection with a broadcast radio station, it will be understood that it can be used with any form of publicly available content, such as broadcast, cable, or satellite television. Instead of entering a radio station frequency or call letters, a user can enter a broadcast, cable, or satellite television channel number, call letters or other identifier. The content application identifies the television station having the selected channel number in the user's area and returns a playlist of recent content on that television station. The user then selects television programs or advertisements of interest, and the content application would provide information about the selected content, such as advertiser contact information.

### Exemplary Implementations

Implementations of the present invention have a common component in the storage of broadcast items. Broadcast or satellite radio stations or broadcast, cable, or satellite television stations send playlist information to Click Host server 108. The information provided preferably includes a content ID tag that is used by the Click Host to match the content with a billable entity, such as an advertiser, and the response event. The response event defines what action is to be taken when this content is selected. For example, the response event may be to send a phone number or webpage address, to connect to webpage, or to send a coupon. The response event may describe what action to take when a purchase is requested, such as when a song is selected and the user is to be connected to a song-selling application or webpage.

In the present description of the invention, the list of content is referred to as a “playlist;” however, it will be understood that in this context the playlist does not need to contain the actual content. In most embodiments, it is expected that the playlist will include only tags that identify the content.

All entities, such as radio or television stations, subscribing to this service will be required to send their playlist to the Click Host. This may be done through any number of means, including file transfer of a scheduled format or real time transmission. Many broadcast stations will select or change their content at the very last possible moment, which would require that the playlist information be streamed in real time or near real time to the Click Host.

Content selection is accomplished by sending a trigger from the mobile device. The mobile device can be a mobile phone or other wireless device, such as a Personal Digital Assistant (PDA), or a digital radio with a select button. Two types of triggers may be used with the present invention. The first trigger type is a range trigger. The range trigger is sent by a device (typically the mobile phone) that does not have exact information regarding the station (radio, TV, cable, satellite, etc) being listened to and regarding the content being requested. The second trigger type is a specific trigger. This is sent by a device that has information about the station being listened to. Typically, this would come from a digital receiver that sent the currently tuned station information. A digital receiver may also send a content tag, if provided in the digital stream. A mobile phone with an integrated broadcast receiver may also send specific triggers. A cable TV receiver could also be a typical device to send a specific trigger.

In the case of a range trigger, the Click Host will return a list of possible content to the sender. The list of possible content may be selected from a period of time that is just prior to the time when the user sent the message. The listener will then pick a specific item or request a different time range. In the case of a specific trigger, the Click Host will optionally send a confirmation message of the selection, or immediately affect the response event for that content.

A first embodiment uses a common text message (SMS) to a common short code with the station call sign in the body of the message as the range trigger. Common Short Codes (CSC) or short number are special telephone numbers, significantly shorter than full telephone numbers, that can be used as the destination address for SMS messages. The content list returned would be a recent block of content preceding the time of the message. All text messages are also provided with information uniquely identifying the source of the message, which will typically be the mobile number of the handset.

A second embodiment is similar to embodiment 1, but allows the user to send the station broadcast frequency in the body of the message. Because frequencies are reused, use of the frequency alone may not provide specific enough information to identify requested content. However, the frequency itself may be used when multiple radio stations with the same frequency have not subscribed to this feature. This embodiment can also use location information provided by the mobile network to identify specific broadcasters. A text message can be augmented with location information sufficient to identify the market area from which the message is originated. Typically this can be done by appending the source point code or MSCID to the message when delivered to the Click Host. Alternatively, the Click Host can issue a specific location request to the mobile using well-known location technologies. Furthermore, the source market location can also be inferred by the area code of the source and assuming that it is not roaming, which would provide enough of an indication to resolve the actual broadcast station.

A third embodiment is based on either embodiment 1 or 2, and further allows the user to add a time in the body of the message. This will cause the Click Host to return the content list nearest the time specified.

A fourth embodiment allows the user to send a keyword or words in the trigger. This will cause the Click Host to search past playlists for content that matches the keyword. The Click Host can search across all broadcast stations or only a subset indicated by the location of the source. The user is then presented with the resultant list of content and can select the specific one, whereby the action event will be triggered.

A fifth embodiment is based on a specific trigger that contains the station ID automatically. This is typically from a mobile phone with an imbedded receiver that provides the currently tuned station information to the trigger message. Alternatively, a digital radio may provide tuned-station information to the trigger message.

A sixth embodiment is based on a specific trigger where the device automatically adds content tags and station information when the user requests information. The specific trigger can be sent as a text message or any of a number of transmissions protocols.

Although the Short Message Service (SMS) protocol has been used herein to describe embodiments of the invention. It will be understood that the invention does not require and is not limited to the use of SMS. Instead, messages having other protocols and formats can be used, such as Enhanced Messaging Service (EMS), Multimedia Messaging Service (MMS), instant messaging, email, WAP or Internet access and proprietary protocols and formats. Moreover, the term broadcast as used herein may refer to, but is not intended to be limited to, over the air (OTA) transmission of content. In this disclosure, the term broadcast is intended to encompass all methods for the transmission of content, including, without limitation, OTA, terrestrial, satellite, wireline, or cable transmission. The present invention may also be used with new content formats, such as a multimedia channel provided by a wireless service operator.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for obtaining information associated with broadcast content, comprising:
sending a broadcast station identifier from a wireless device;
receiving a playlist of content broadcast on a broadcast station that corresponds to the broadcast station identifier;
identifying content of interest from the playlist; and
receiving, at the wireless device, content information associated with the identified content.

2. The method of claim 1 further comprising:
displaying the playlist to a user; and
displaying the content information to a user.

3. The method of claim 1 further comprising:
dialing a telephone number received in the content information.

4. The method of claim 1 further comprising:
displaying content from an Internet website to the user, wherein the Internet website is identified in the content information.

5. The method of claim 1 further comprising:
displaying the playlist as a menu on the wireless device; and
identifying content of interest by selecting a menu item.

6. The method of claim 1 wherein the broadcast station identifier is sent using a format selected from the group consisting of:
short message service;
multimedia message service;
instant message service; and
electronic mail.

7. A method for providing content information to a wireless device, comprising:
receiving a station identifier and mobile switching center information, wherein the mobile switching center information is associated with the wireless device;
identifying a station associated with the station identifier;
sending a playlist of content broadcast on the station to the wireless device;
receiving an identifier for specific content in the playlist; and
sending content information associated with the specific content to the wireless device.

8. The method of claim 7, further comprising:
aggregating multiple playlists from multiple stations into a single searchable database.

9. The method of claim 7, wherein the station is selected from the group consisting of:
an over-the-air radio station;
an over-the-air television channel;
a satellite radio channel;
a satellite television channel;
a cable television channel; and
a multimedia channel carried on a wireless network.

10. The method of claim 7 wherein the mobile switching center information is a location of the wireless device.

11. The method of claim 7 wherein the mobile switching center information is a mobile switching center identifier, the method further comprising:
determining a location of a mobile switching center using the mobile switching center identifier.

12. The method of claim 7 wherein the playlist is a menu list of content broadcast on the station.

13. The method of claim 7 wherein the content broadcast comprises content selected from the group consisting of:
songs;
advertisements;
news;
commentary;
public service announcements; and
sports.

14. The method of claim 7 wherein the content information comprises content selected from the group consisting of:
telephone numbers;
website addresses;
product information;
service information;
contact information;
statistical information;
sport score information;
price information;
artist information; and
song lyrics.

15. A method for providing content information to a wireless device, comprising:
receiving a first message comprising a station identifier and a wireless device identifier;
forwarding the first message to an application for identifying a station associated with the station identifier;
receiving a second message comprising a playlist of content broadcast on the station;
forwarding the second message to the wireless device;
receiving a third message comprising a request for information associated with content listed on the playlist;
forwarding the third message to an application for retrieving information associated with listed content;
receiving a fourth message comprising content information; and
forwarding the fourth message to the wireless device.

16. The method of claim 15 wherein the application for identifying a station and the application for retrieving information are co-located.

17. The method of claim 15, wherein the application for identifying a station and the application for retrieving information reside on a server that aggregates multiple playlists from multiple stations into a single searchable database.

18. The method of claim 15, wherein the station identifier is selected from the group consisting of:
digits representing a radio frequency or channel number;
a call sign assigned to a broadcast station;
a name of a broadcast network channel; and
a name of a broadcast network company.

19. The method of claim 15, wherein the application for retrieving information is controlled by an entity associated with the station identifier.

20. The method of claim 15, wherein the application for identifying a station uses location information for the wireless device to identity the station.
